(19) United States
(12) Patent Application Publication
(10) Pub. No.: US 2002/0015056 A1
(43) Pub. Date: Feb. 7, 2002

(54) Dynamic help system for a data processing device

(76) Inventor: Markus Weinlaender, Happurg (DE)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/793,892

(22) Filed: Feb. 28, 2001

(30) Foreign Application Priority Data
Feb. 29, 2000 (DE) 10009297.7

(51) Int. Cl. G06F 3/00

(52) U.S. Cl. 345/705

(57) ABSTRACT

A help system having a first generator (110) for dynamically generating a user profile data set. This user profile data set stores, in particular with reference to a time base (140), help topic data sets (130) and/or the frequency and/or the type of a user's access to utilization functions of a software program. The help system further includes a second generator (150) for generating a user help profile data set. In this user help profile data set (150), at least selected help topic data sets (130), or program branches therefor, are stored as a function of the access data recorded in the user profile data set (110). Based on the user help profile data set (150), at least one user-specific help startup page (120) is dynamically generated, which allows for activating the help topic data sets (130) associated with the user help profile data set (150).

This Application claims priority from German Application number 10009297.7 with a filing date of Feb. 29, 2000, the disclosure of which is incorporated into this application by reference.

### FIELD OF AND BACKGROUND OF THE INVENTION

The present invention relates to a help system for an application program and/or an operating system program. Therein, the help system includes data sets with respect to help topics, to which utilization functions of the application program and/or the operating system program are assigned.

Data processing programs are generally equipped with so-called help systems. A help system is a library of information that the users of the program can access, for instance if they have questions regarding the operation of the program. An example of such a help system is described in U.S. Pat. No. 5,715,415, which is assigned to Microsoft Corporation.

FIG. 1 illustrates the structure of a known help system for an exemplary computer system. The computer system has, for example, at least one input unit 3, e.g., a keyboard, with which a user can access a processing unit 4 such as a processor. In this processing unit 4, there are stored an operating system 2 and several application programs 1a, 1b, and 1c, for example. Data sets of help topics are assigned to utilization functions of each application program, such as utilization functions 100 of the application program 1a. In addition, data sets of help topics are assigned to utilization functions of the operating system 2, such as utilization functions 100a of the operating system 2. The user can access these data sets via the input unit 3, e.g., by means of searches or direct queries 301, 302. The selected help topics are then output on a display unit 6 via an output channel 61.

The known help systems of this type have the disadvantage that the manner in which they permit the user to access the help topics is relatively rigid and inflexible. The help topics that are available for the operating system and the application programs are usually compiled in the form of a more or less alphabetically structured table of contents and/or a directory. Similar to searching in a library or a dictionary, the user must search these directories before the user is able to activate and display one of the available data sets for a help topic. This, however, is time consuming. It also requires a certain basic knowledge on the part of the user in order to find the needed help data sets in these directories. If the user does not have this knowledge, he or she may fail in his or her search for a required help topic. As a result, users often consider the help systems of graphic user interfaces (e.g. in standard personal computer operating systems) and the associated application programs to be somewhat counter-intuitive. The reason for this is that the navigation through these help systems is frequently too abstract, overly formalized, and consequently not sufficiently adapted to a user's needs.

### OBJECTS OF THE INVENTION

It is one object of the present invention to provide a help system, which has, compared to prior art help systems, more flexible capabilities to access help topics, in particular help topics that are of current interest to a user.

### SUMMARY OF THE INVENTION

This and other objects are achieved by a help system for a software program, wherein the help system includes a first generator and a second generator. The first generator generates dynamically a user profile data set. This user profile data set includes a frequency and/or a type of the user's access to utilization functions of the software program and/or to help topic data sets, wherein the help topic data sets are assigned to the utilization functions. The second generator generates dynamically a user help profile data set. This user help profile data set includes selected data sets of the help topic data sets and/or program branches that lead to the selected data sets. Therein, the selected data sets and the program branches are selected in accordance with the frequency and/or the type of the user's access, which are included in the user profile data set.

The invention further relates to a computer operating system, a storage medium, a computer facility, and a computer network, each of which is equipped with a help system according to the invention.

The help system according to the invention has the particular advantage that it selects specific help topic data sets from all the help topic data sets available, wherein this selection is dynamically dependent on a user's actual access frequency and actual types of access. Thus, the help system dynamically adapts to the frequency and the type of a user's use of the utilization functions. This allows for generating a specific selection from the total number of all available help topic data sets.

This selection can take various criteria into account. For instance, when certain utilization functions are used, the user help profile data set may include help topics that provide in-depth information on these utilization functions. On the other hand, the user help profile data set may also include help topics pertaining to utilization functions that the user has only rarely used thus far or that the user has not used at all. Also, the user may take suggestions from these dynamically offered help topics, which will enable him or her to optimize his or her future access to utilization functions or to certain data types.

When a user profile data set is dynamically generated, it is particularly advantageous if a user's detected types of access are stored in the help system according to the invention with reference to a time base. Advantageously, a time stamp is then assigned to each detected access. In this case, based on an analysis of the time-based occurrence of these types of access, dynamically selected help topic data sets and/or program branches thereto can be stored in the user help profile data set. For example, if a user currently accesses certain utilization functions, the help system, for the time being, does not store the associated help topics in the help profile data set, since it can be assumed that the user does not need any further information on this specific type of access. On the other hand, the help system can select related help topics, which are associated with types of access that the user has only rarely used or that the user has not used at all but which are in a certain relationship with the frequently used types of access. Thus, additional help topics can be dynamically offered to the user, which contain information with regard to further types of access that the user may previously not have been aware of in terms of their full potential and scope.

It is particularly advantageous that the dynamic generation of a user profile data set according to the invention and the generation of a user-specific user help profile data set derived therefrom, in particular with reference to a time base, allow for a dynamic selection of help topics.

The help system according to the invention can record the following exemplary types of access in order to generate the user profile data set: the types of the activated user functions; the data types processed by the activated user functions; and the user's dialog techniques to activate the user functions. As the dialog techniques, the help system according to the invention records access types, which are available to a user to operate the utilization functions, e.g., operating the mouse, activating selected program menus, etc. If the help system according to the invention detects that certain ones of the dialog techniques are frequently used, then the help system can provide basic help topics, which relate to unused or rarely used dialog techniques, or in-depth help topics, which relate to frequently used dialog techniques, for example.

It is particularly advantageous that the help system according to the invention dynamically generates at least one user-specific help startup page. This help startup page enables the user to activate at least a selection of the help topic data sets that pertain to this user's user help profile data set. This help startup page is an up-to-date information page that is updated on a daily basis, for example, and by means of which a specific selection of help topics is offered to the user. This specific selection of help topics reflects the dynamic content of the user profile data set.

### BRIEF DESCRIPTION OF THE DRAWINGS

The invention and further advantageous refinements of the invention according to the features of the dependent claims are explained in more detail below with the aid of diagrammatic, exemplary embodiments in the drawings, in which:

FIG. 1: shows the essential elements of a related data processing system and available help topic data sets associated therewith;

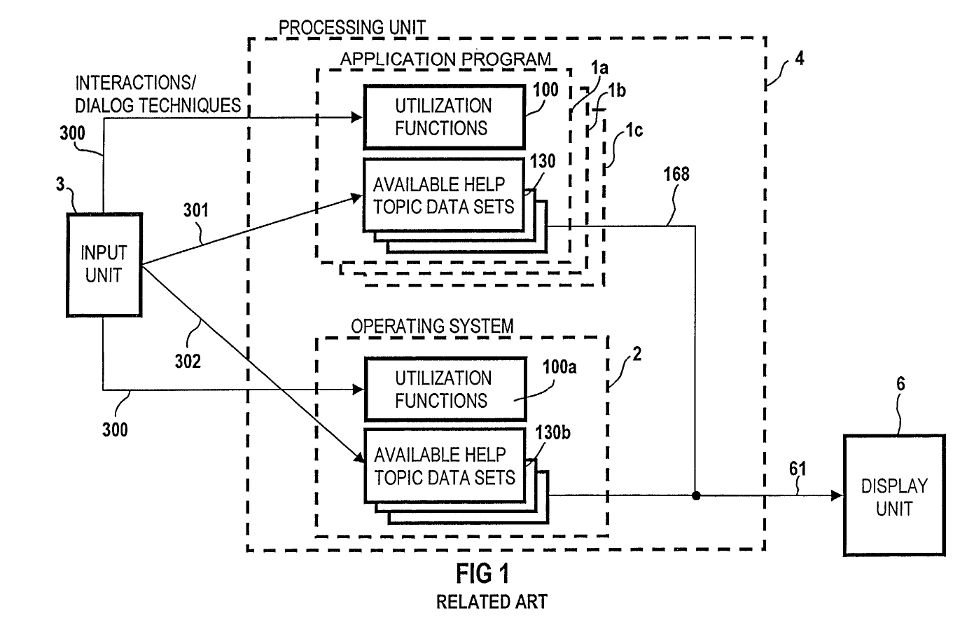

FIG. 2: shows an exemplary data processing system, together with a first embodiment of the dynamic help system according to the invention, wherein, according to the invention, at least one user-specific help startup page with respect to an individual application program is dynamically generated, for example;

FIG. 3: shows a preferred embodiment of a dynamic help startup page according to the invention,

FIG. 4: shows an exemplary data processing system, together with a second embodiment of a dynamic help system according to the invention, wherein, according to the invention, at least one user-specific help startup page with respect to several application programs is dynamically generated; and

FIG. 5: is a preferred embodiment of the structure of a subroutine to initialize dynamic help startup pages according to the invention.

### DETAILED DESCRIPTION OF THE PREFERRED EMBODIMENTS

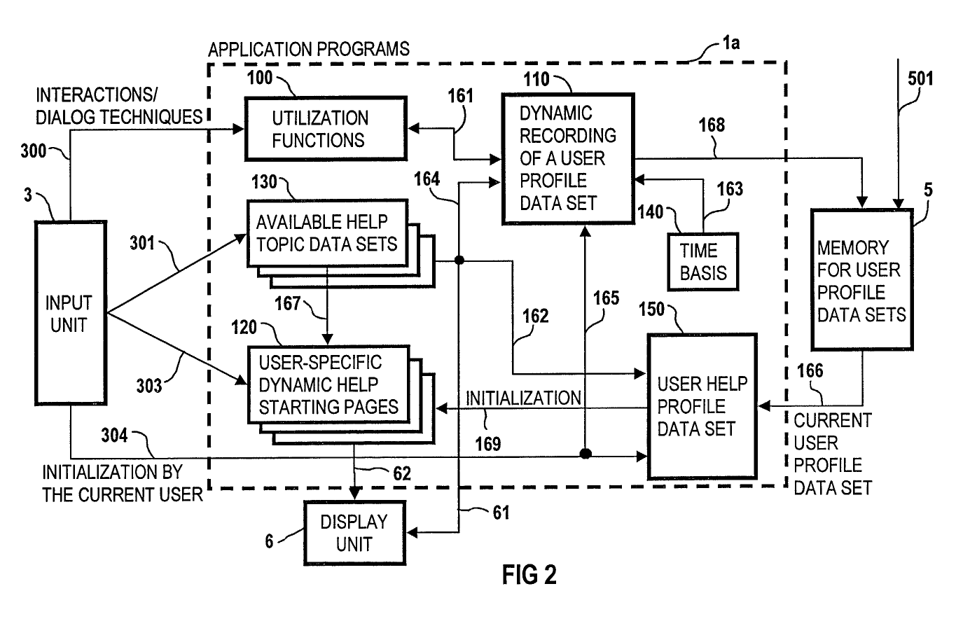

FIG. 2 shows a first exemplary embodiment of a help system according to the invention. This figure shows an application program 1a, which has utilization functions 100. A user can access these utilization functions 100 by means of an input unit 3 and by means of various dialog techniques 300, in particular software-implemented dialog techniques. Preferred dialog techniques are, for instance, activating tool bars, hotkeys, menus, contextual menus, direct manipulations, etc. According to the invention, at least the frequency and/or the types of access to the utilization functions 100 are dynamically, i.e., in particular cyclically and/or event-controlled, recorded by a component 110 via a data interface 161. The access frequency and/or the types of access are used to generate a user profile data set. Such a user profile data set 110 is advantageously assigned to a specific user via initialization data 165. The user himself/herself may enter the initialization data 165 into the application program 1a via the input unit 3.

Since a user can still access the group of available help topic data sets 130 directly, it is advantageous that the component 110 records the frequency and/or the types of this access via a data interface 164 too, and that the component 110 includes the frequency and/or the types of this access in the user profile data set 110 too. It is furthermore advantageous if time stamps are assigned to the recorded types of access in the user profile data set 110, which can be called up from a time base 140 via a data interface 163. Advantageously, the user profile data set 110, which is assigned to a user, is stored in a memory unit 5 via a data interface 168. Respective user profile data sets 110 of other users may be intermediately stored in the memory 5 via a further data interface 501.

The dynamically recorded user profile data set 110 according to the invention allows for compiling a selection of help topics that are currently relevant to the user. This selection is compiled in the form of a user help profile data set 150 and tailored to the needs of the user. If the user profile data set 110 is intermediately stored in the memory unit 5, then the user profile data set 110 can be loaded via a data interface 166. Advantageously, the user help profile data set 150 stores branch addresses only, which lead to the data sets of the selected help topics by means of a data interface 164.

According to the preferred embodiment of the invention depicted in FIG. 2, the user help profile data set 150 is used to dynamically generate an individual, user-specific help startup page 120, which is then output on a display unit 6 via an output channel 62. As noted above, the user help profile data set 150 preferably contains branch addresses only. In this case, the contents of the data sets of the selected help topics can be called up directly from the file 130 via a data interface 167. The data file 130 contains all available help topic data sets. The help topic data sets that are directly and interactively activated by the user via a data interface 301 can of course, in addition to the dynamic help startup page 120, also be output on the display unit 6 via an output channel 61.

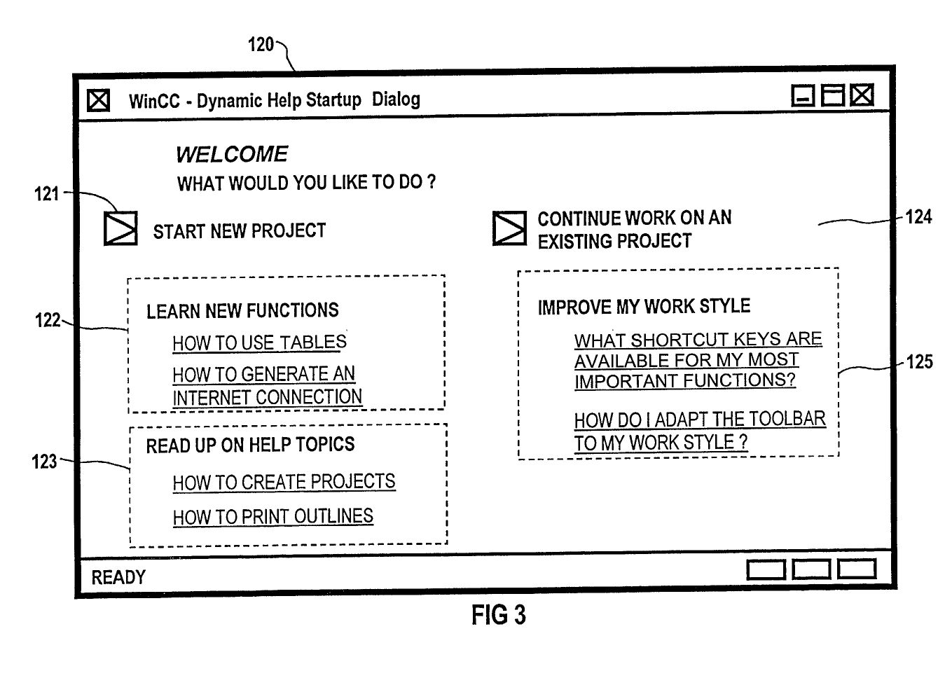

FIG. 3, by way of example, shows a user-specific dynamic help startup page 120, which is designated as “WinCC—Dynamic Help Startup Dialog”. This dynamic help startup page 120 has, for instance, three groups of help topics that were dynamically compiled by means of the user profile data set 110.

A first group of help topics 121 relates to help topics that may be relevant if the user wants to start a new task or project with the aid of a utilization function 100. The help topics “How to use tables” and “How to generate an Internet connection” are dynamically offered under the heading “LEARN NEW FUNCTIONS” 122, whereas the help topics “How to create projects” and “How to print outlines” are dynamically offered under the heading “READ UP ON HELP TOPICS” 123. The heading 122 thus relates to hints and/or links to help topics that are new to the user, that have only rarely been used by the user, or that have not been used by the user at all. The heading 123 relates to hints and/or links to help topics that have been intensively used by the user in terms of memory, learning and repetition functions.

In contrast, the second group of help topics 124 relates to the case where the user wants to continue work on an existing project. In the preferred embodiment of FIG. 3, under the heading “IMPROVE MY WORK STYLE” 125, branches to dynamically selected help topics are offered, which contain hints that may improve the user's dialog technique and/or the user's technique on how to interactively communicate with the data processing device. An exemplary help topic relates to the question “What shortcut keys are available for my most important functions?”, while a second exemplary help topic deals with the question “How do I adapt the toolbar to my work style?”.

According to the invention, the topic headings 122, 123, and 125 are selected based on information on the user's frequency and/or types of access to the utilization functions of application programs. This information is contained in the respective user profile data set 110. The content of the help startup page 120 can thus continuously and dynamically change since, based on changes in the user's access behavior, the representation of the user's utilization focus or utilization habits in the form of the user profile data set 110 is also continuously changed. If time stamps are assigned to the information contained in the user profile data set 110, “aging” aspects may be taken into account when the help topics are dynamically selected. This includes, for instance, the questions of how long a help topic has already been offered on the help startup page 120 or since when the user has not performed certain types of access.

In addition, the help system according to the invention allows for taking the user's learning characteristics into account, i.e., the user's learning characteristics are dynamically used for generating the user profile data set 110 and the user help profile data set 150, which is based on the user profile data set 110. The help system according to the invention thus responds dynamically to the user's needs in order to learn together with the user.

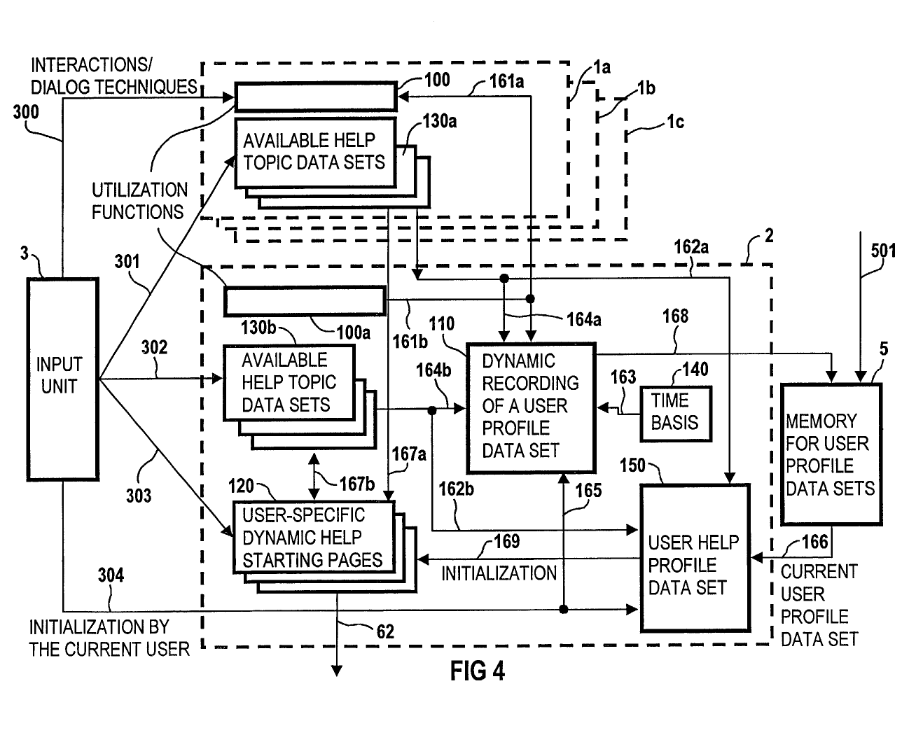

FIG. 4 shows another preferred embodiment of the help system according to the invention. This preferred embodiment is different from the preferred embodiment shown in FIG. 2 in that help topic data sets 130a are available not only for the utilization functions 100 of the application programs 1a, 1b, 1c. Rather, the exemplary computer system shown in FIG. 4 has an operating system 2, which has its own utilization functions 100a, to which help topic data sets 130b are assigned.

In this case, when the user profile data set 110 according to the invention is generated, it is advantageous that accesses to the utilization functions 100 of the application programs 1a, 1b, 1c and accesses to the utilization functions 100a of the operating system 2 are dynamically recorded via data interfaces 161a and 161b, respectively. By the same token, the user's direct access to the data sets 130a for application-specific help topics and to the data sets 130b for operating-system-specific help topics via data interfaces 164a and 164b, respectively, is also represented in the user profile data set 110. In this preferred embodiment too, the entries in the user profile data set 110 are advantageously provided with time stamps from the time base 140 and are, when appropriate, intermediately stored in the memory unit 5. Advantageously, the user help profile data set 150 in the preferred embodiment of FIG. 4, which is based on the user profile data set 110, contains only program branches to data sets of selected help topics that can be loaded via data interfaces 162a and 162b. The content of the user help profile data set 150, in turn, effects initialization of at least one user-specific and dynamic help startup page 120 via a data interface 169. If a user updates a help topic in the startup page 120, the associated data set is advantageously directly loaded from the group of available help topic data sets 130a, 130b of the application program 1a, 1b, 1c and the operating system 2 via data interfaces 167a and 167b, respectively.

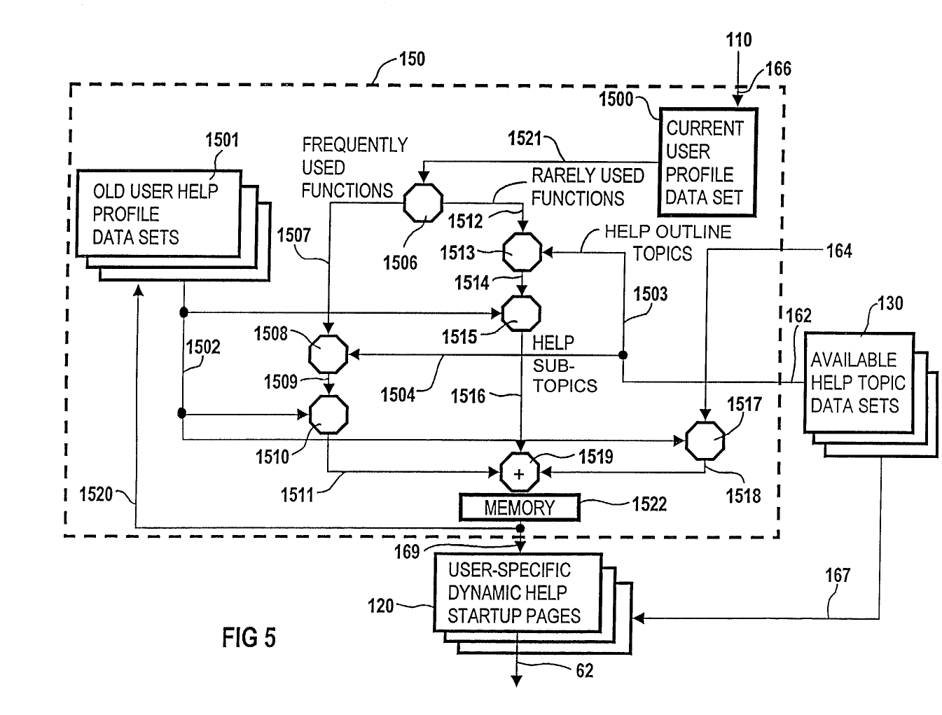

Finally, the preferred embodiment shown in FIG. 5 illustrates an exemplary structure of the user help profile data set 150. This user help profile data set 150 is supplied with a current user profile data set 110 via a data interface 166 and is intermediately stored in an element 1500, for example. Furthermore, in particular the branch addresses of the data sets 130 of all available help topics are accessed via a data interface 162. As a result, through the user help profile data set 150, at least one application-specific and dynamic help startup page 120 is initialized via a data interface 169. This startup page 120 is output on a display unit 6 via an output channel 62. If a user calls up a help topic, the associated data set is advantageously directly loaded from the group of all available data sets 130 via a data interface 167. With respect to this external connection diagram, the representation in FIG. 5 thus corresponds to the preferred embodiment shown in FIG. 2.

In the preferred embodiment shown in FIG. 5, processing units 1506, 1508, 1510, 1513, 1515, 1517 and 1519 are provided for generating a user help profile data set. These processing units are advantageously software-implemented in the form of program codes. In addition, an intermediate memory 1501 is provided for storing old user-specific help profile data sets, i.e., help profile data sets that were used in the past to initialize previously displayed “old” help startup pages.

The contents of the user profile data set 1500 are accessed by the processing unit 1506 via a data interface 1521. Therein, the processing unit 1506 filters out entries that are related to utilization functions that the user frequently used in the past. These entries are supplied to the processing unit 1508 via a data interface 1507. In addition, entries that are related to utilization functions that the user rarely used in the past are filtered out as well. These entries are supplied to the processing unit 1513 via a data interface 1512.

In the processing unit 1508 and via a data interface 1504, at least the branch addresses of special help subtopics are assigned to the entries associated with the frequently used utilization functions. The purpose of this is to offer the user in-depth information on frequently used functions. This data is supplied to the processing unit 1510 via a further data interface 1509. In the processing unit 1510, this data is linked with the content of old intermediately stored user help profile data sets from the memory 1501 by means of a connection 1502. The result of this link thus contains only the branch addresses of those special help subtopics that, in the past, have not been output on a dynamic help startup page, for example. These branch addresses are written into a memory 1522 via a data interface 1511 and via a processing unit 1519, which has a summation function. In the memory 1522, all components that determine the dynamic content of a current help profile data set 150 are combined.

Furthermore, in the processing unit 1513 and via a data interface 1503, at least the branch addresses of general help overview topics are assigned to those entries that relate to rarely used utilization functions. The purpose of this is to offer the user basic information on rarely used functions. This data is supplied to the processing unit 1515 via a further data interface 1514. In the processing unit 1515, this data is linked with the content of old intermediately stored user help profile data sets from the memory 1501 by means of the connection 1502. The result of this link thus contains only the branch addresses of those general help outline topics that, in the past, have not been output on a dynamic help startup page, for example. These branch addresses are written into the memory 1522 via a data interface 1516 and via the processing unit 1519, which has a summation function. The memory 1522 contains all components of the current help profile data set 150.

The branch addresses of those help topic data sets that are directly requested by the user are supplied to the processing unit 1517 via a data interface 164. In the processing unit 1517, this data is linked with the content of old intermediately stored user help profile data sets from the memory 1501 by means of the connection 1502. The result of this link thus contains only the branch addresses of those help topics that, in the past, have not been output on a dynamic help startup page, for example. Via a data interface 1518 and via the processing unit 1519, which has a summation function, these branch addresses are written into the memory 1522, which contains all the components of the current help profile data set 150.

Finally, the content of the memory 1522 is used to initialize a dynamic help startup page via a data interface 169, for example.

The help system according to the invention is advantageously used in computer operating systems, computer facilities, and computer networks, which contain at least one application program and/or operating system program. The help system according to the invention may also be included in a computer operating system that is stored on a storage medium. The aforementioned computer facilities include, for instance, stand-alone applications or desktop applications. The afore-mentioned computer networks include those based on communication via the Internet.

The help system according to the invention offers the particular advantage that it not only performs the conventional function of a reference system but also the function of a “coach.” This helps the user to gradually learn how to use a respective software program. The combination of a user profile data set and a user help profile data set allows for accessing help topic data sets that are dynamically tuned to the user's learning progress and that contain hints or suggestions with regard to help topics that are currently needed by the user.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A help system for at least one software program, comprising:
a first generator to dynamically generate a user profile data set, wherein the user profile data set includes at least one of a frequency and a type of a user's access to at least one of (i) utilization functions of the software program and (ii) help topic data sets, wherein the help topic data sets are assigned to the utilization functions; and
a second generator to dynamically generate a user help profile data set, wherein the user help profile data set includes at least one of (i) selected data sets of the help topic data sets and (ii) program branches that lead to the selected data sets, wherein the selected data sets and the program branches are selected in accordance with at least one of the frequency and the type of the user's access included in the user profile data set.

2. The help system according to claim 1, wherein the software program comprises at least one of an application program and an operating system program.

3. The help system according to claim 1, wherein the first generator is structured to dynamically include, with reference to a time basis, the at least one of the frequency and the type of the user's access to the at least one of the utilization functions and the help topic data sets in the user profile data set.

4. The help system according to claim 1, wherein the type of the user's access comprises categories of the utilization functions activated by the user.

5. The help system according to claim 4, wherein the type of the user's access comprises types of data processed by the utilization functions activated by the user.

6. The help system according to claim 1, wherein the type of the user's access comprises dialog techniques utilized by the user to activate the utilization functions.

7. The help system according to claim 1, further comprising:
a third generator to dynamically generate at least one user-specific help startup page to activate at least a portion of the selected data sets of the user help profile data set.

8. The help system according to claim 7, wherein the user help profile data set comprises comparators with which a content of a current user-specific help startup page is dynamically adapted with respect to a content of prior help startup pages.

9. The help system according to claim 8, wherein the comparators activate respective ones of the selected data sets that are not included in the prior help startup pages.

10. The help system according to claim 1, further comprising:
a third generator to dynamically generate at least one user-specific help startup page to activate at least a portion of the program branches of the user help profile data sets.

11. The help system according to claim 10, wherein the user help profile data set comprises comparators with which a content of a current user-specific help startup page is dynamically adapted with respect to a content of prior help startup pages.

12. The help system according to claim 11, wherein the comparators activate respective ones of the program branches that are not included in the prior help startup pages.

13. A computer operating system comprising a help system for at least one software program, wherein the help system comprises:
a first generator to dynamically generate a user profile data set, wherein the user profile data set includes at least one of a frequency and a type of a user's access to at least one of (i) utilization functions of the software program and (ii) help topic data sets, wherein the help topic data sets are assigned to the utilization functions; and
a second generator to dynamically generate a user help profile data set, wherein the user help profile data set includes at least one of (i) selected data sets of the help topic data sets and (ii) program branches that lead to the selected data sets, wherein the selected data sets and the program branches are selected in accordance with at least one of the frequency and the type of the user's access included in the user profile data set.

14. A storage medium comprising a computer operating system including a help system for at least one software program, wherein the help system comprises:
a first generator to dynamically generate a user profile data set, wherein the user profile data set includes at least one of a frequency and a type of a user's access to at least one of (i) utilization functions of the software program and (ii) help topic data sets, wherein the help topic data sets are assigned to the utilization functions; and
a second generator to dynamically generate a user help profile data set, wherein the user help profile data set includes at least one of (i) selected data sets of the help topic data sets and (ii) program branches that lead to the selected data sets, wherein the selected data sets and the program branches are selected in accordance with at least one of the frequency and the type of the user's access included in the user profile data set.

15. A computer facility comprising a help system for at least one software program, wherein the help system comprises:
a first generator to dynamically generate a user profile data set, wherein the user profile data set includes at least one of a frequency and a type of a user's access to at least one of (i) utilization functions of the software program and (ii) help topic data sets, wherein the help topic data sets are assigned to the utilization functions; and
a second generator to dynamically generate a user help profile data set, wherein the user help profile data set includes at least one of (i) selected data sets of the help topic data sets and (ii) program branches that lead to the selected data sets, wherein the selected data sets and the program branches are selected in accordance with at least one of the frequency and the type of the user's access included in the user profile data set.

16. A computer network comprising a help system for at least one software program, wherein the help system comprises:
a first generator to dynamically generate a user profile data set, wherein the user profile data set includes at least one of a frequency and a type of a user's access to at least one of (i) utilization functions of the software program and (ii) help topic data sets, wherein the help topic data sets are assigned to the utilization functions; and
a second generator to dynamically generate a user help profile data set, wherein the user help profile data set includes at least one of (i) selected data sets of the help topic data sets and (ii) program branches that lead to the selected data sets, wherein the selected data sets and the program branches are selected in accordance with at least one of the frequency and the type of the user's access included in the user profile data set.
